(19) United States
(12) Patent Application Publication
(10) Pub. No.: US 2024/0340642 A1
(43) Pub. Date: Oct. 10, 2024

(54) Encryption Key for Inter-Network Communications

(71) Applicant: Ademco Inc., Golden Valley, MN (US)

(72) Inventor: Steven C. Nichols, Plymouth, MN (US)

(73) Assignee: Ademco Inc., Golden Valley, MN (US)

(21) Appl. No.: 18/579,314

(22) PCT Filed: Jul. 22, 2021
(86) PCT No.: PCT/US2021/042830

§ 371 Date: Jan. 12, 2024

(51) Int. Cl. H04W 12/0431; H04W 12/033; H04W 12/041

(52) U.S. Cl. CPC H04W 12/0431; H04W 12/033; H04W 12/041

(57) ABSTRACT

A first host device in a first network of a plurality of networks may receive, from an intermediate client device, a request to enroll the intermediate client device into the first network, including receiving a candidate inter-network encryption key. The first host device may determine whether any other intermediate client device is already enrolled in the first network. The first host device may, in response to determining that no other intermediate client device is already enrolled in the first network, set the candidate inter-network encryption key as an inter-network encryption key of the first host device for encrypting communications between the plurality of networks. The first host device may send, to the intermediate client device for forwarding to a second host device in a second network of the plurality of networks, an encrypted message that is encrypted using the inter-network encryption key of first host device.

### TECHNICAL FIELD

The disclosure relates to encrypted communications between networks.

### BACKGROUND

The Internet of Things (IoT) describes a network of physical objects that can connect and exchange data with devices and systems over networks. In particular, in the field of home automation, smart devices may connect to building control units and systems via wired and/or wireless networks to control such building control units and systems. For example, a building may include a heating, ventilation, and air conditioning (HVAC) systems for heating and cooling the building, where the HVAC system may provide a wireless network with which a thermostat controller device and one or more sensors may connect in order to control the HVAC system.

### SUMMARY

In general, this disclosure relates to techniques for devices in different networks to securely communicate with each other. A host device in a network may communicate with client devices in the network. For example, a building may include two or more HVAC systems for heating and cooling corresponding areas or zones of the building, where each HVAC system may provide a wireless network with which a thermostat controller device and one or more sensors may connect in order to control the HVAC system. In this example, the thermostat controller device may be a host device, and the one or more sensors may be client devices in the network.

A host device of a network may communicate with another host device of another network via one or more intermediate client devices. An intermediate client device may be a client device, such as a sensor, that can enroll in (e.g., connect to) two or more networks. In the example of a building with two HVAC systems that each provides a network, an intermediate client device may connect to each of the two networks provided by the two HVAC systems. Thus, a thermostat controller device of a first HVAC system connected to a first network provided by a first HVAC system may communicate with a thermostat controller device of a second HVAC system connected to a second network provided by a second HVAC system via an intermediate client device that is enrolled in both the first network and the second network. For example, the intermediate device may connect to each of the two networks to provide clock synchronization information to the thermostat controller device of each of the two HVAC systems to synchronize the clocks of the two thermostat controller devices to each other.

To increase security, a host device of a network may use a security key to encrypt and decrypt communications between the host device of a network and client devices of the network. Further, in order to encrypt inter-network communications between networks, host devices may use an inter-network security key to encrypt and decrypt inter-network communications carried by intermediate client devices between two or more networks. However, because host devices of different networks are unable to directly communicate with each other, it may be potentially challenging to distribute the same inter-network encryption key across host devices of different networks, so that host devices of different networks may use the same inter-network encryption key to encrypt and decrypt inter-network communications carried by intermediate client devices between two or more networks.

Aspects of the present disclosure describe techniques for distributing an inter-network encryption key across host devices of different networks using intermediate client devices. By using intermediate client devices to distribute the same inter-network encryption key across host devices of different networks, the techniques of this disclosure improve the security of inter-network communications by enabling host devices across different networks to receive and use the same inter-network encryption key to encrypt and decrypt inter-network data, thereby providing one or more technical advantages.

In another example, the disclosure is directed to a method that includes receiving, by a first host device in a first network of a plurality of networks from an intermediate client device, a request to enroll the intermediate client device into the first network, including receiving, by the first host device from the intermediate client device, a candidate inter-network encryption key; determining, by the first host device, whether any other intermediate client device is already enrolled in the first network; determining, by the first host device and based at least in part on the determination of whether any other intermediate client device is already enrolled in the first network, the candidate inter-network encryption key as an inter-network encryption key of the first host device for encrypting communications between the plurality of networks; and sending, by the first host device in the first network to a second host device in a second network of the plurality of networks, an encrypted message that is encrypted using the inter-network encryption key of the first host device.

In another example, the disclosure is directed to a host device that includes communication circuitry configured to connect to a first network of a plurality of networks; memory; and processing circuitry operably coupled to the memory and communication circuitry and configured to: receive, from an intermediate client device via the communication circuitry, a request to enroll the intermediate client device into the first network; determine whether any other intermediate client device is already enrolled in the first network; determine, based at least in part on the determination of whether any other intermediate client device is already enrolled in the first network, the candidate inter-network encryption key as an inter-network encryption key of the host device for encrypting communications between the plurality of networks; and send, send, to a second host device in a second network of the plurality of networks, an encrypted message that is encrypted using the inter-network encryption key of the first host device.

In another example, the disclosure is directed to a method that includes enrolling, by an intermediate client device, in a first network of a plurality of networks, including receiving, by the intermediate client device from a first host device of the first network, a first inter-network encryption key for encrypting communications between the plurality of networks; enrolling, by the intermediate client device, in a second network of the plurality of networks, including receiving, by the intermediate client device from a second host device of the second network, a second inter-network encryption key for encrypting communications between the plurality of networks; and in response to determining that the first inter-network encryption key does not match the second inter-network encryption key, broadcasting, by the intermediate client device across the plurality of networks, the second inter-network encryption key for encrypting communications between the plurality of networks.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating an example system in which devices in a plurality of networks may securely communicate with each other via encrypted messaging, in accordance with aspects of the present disclosure.

FIG. 2 is a block diagram illustrating an example host device, in accordance with one or more techniques described herein.

FIG. 3 is a block diagram illustrating an example intermediate client device, in accordance with one or more techniques described herein.

FIGS. 4A-4D are block diagrams illustrating an example technique for exchanging inter-network encryption keys between host devices, in accordance with aspects of the present disclosure.

FIGS. 5A-5F are block diagrams illustrating an example technique for exchanging inter-network encryption keys between host devices, in accordance with aspects of the present disclosure.

FIG. 6 is a flow diagram illustrating an example operation of a host device of a network for enrolling an intermediate client device in the network, in accordance with aspects of the present disclosure.

FIG. 7 is a flow diagram illustrating an example operation of an intermediate client device that enrolls in a network by communicating with a host device of the network, in accordance with aspects of the present disclosure.

FIG. 8 is a flow diagram illustrating an example operation of a host device a network that enrolls an intermediate client device in the network, in accordance with aspects of the present disclosure.

FIG. 9 is a flow diagram illustrating an example operation of an intermediate client device that may enroll in two or more networks, in accordance with aspects of the present disclosure.

### DETAILED DESCRIPTION

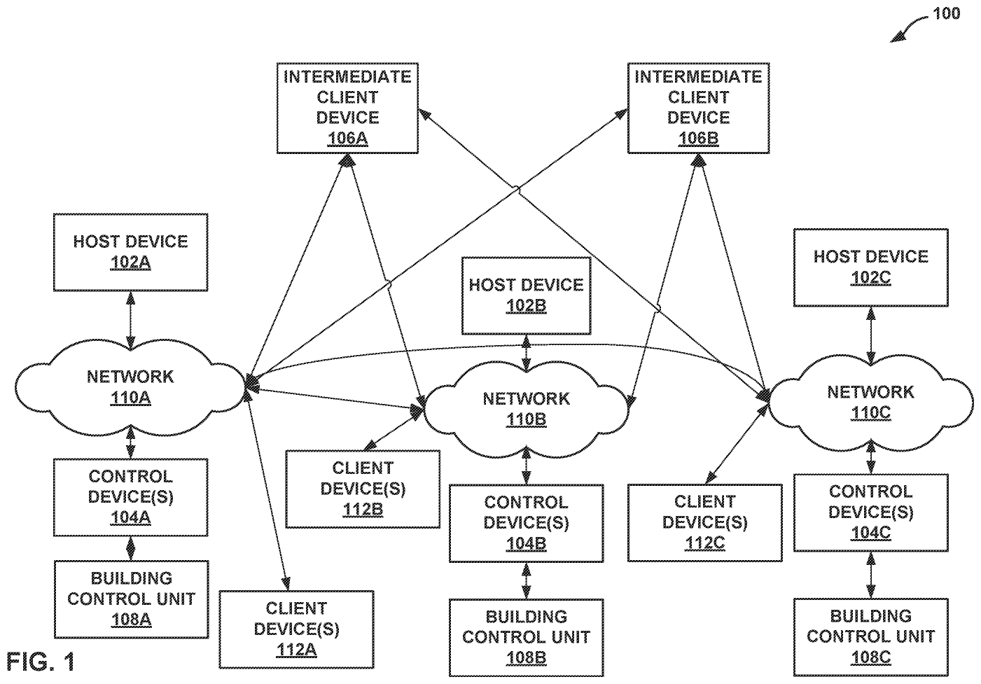

FIG. 1 is a block diagram illustrating an example system 100 in which devices in a plurality of networks may securely communicate with each other via encrypted messaging, in accordance with aspects of the present disclosure. As shown in FIG. 1, system 100 may be a building automation system for a building or a structure, and may include a plurality of building control units 108A-108C (“building control units 108”).

Examples of building control units 108 may include one or more HVAC systems for regulating the temperature of one or more rooms and/or zones of a building or structure, one or more lighting systems for controlling the lighting of one or more rooms and/or zones of a building or structure, one or more security systems for providing and controlling alarms and security services for one or more rooms and/or zones of a building or structure, and the like. In the example of a building, such as a large home, having multiple HVAC systems, each of building control units 108 may represent a separate HVAC system in the building, where each of building control units 108 may regulate the heating and cooling of one or more zones of the building.

Each of building control units 108 is associated with a control device that is configured provide one or more control signals for controlling building control units 108 of building control systems 120. For example, building control unit 108A is associated with control device 104A configured to provide one or more control signals for controlling building control unit 108A, building control unit 108B is associated with control device 104B configured to provide one or more control signals for controlling building control unit 108B, and building control unit 108C is associated with control device 104C configured to provide one or more control signals for controlling building control unit 108C. Examples of control devices 104A-104C (“control devices 104”) include any combination of a HVAC control device used to communicate and control one or more HVAC components, a security control device used to communicate and control one or more security components, a lighting control device used to communicate with and control one or more lighting components, an access control device used to communicate and control one or more access control units, and the like.

Control devices 104 may include any one or more microprocessors, digital signal processors (DSPs), application specific integrated circuits (ASICs), field programmable gate arrays (FPGAs), or any other equivalent integrated or discrete logic circuitry, as well as any combinations of such components. When the control devices 104 includes software or firmware, the client devices may further include any necessary hardware for storing and executing the software or firmware, such as one or more processors or processing units. In general, a processing unit may include one or more microprocessors, DSPs, ASICs, FPGAS, or any other equivalent integrated or discrete logic circuitry, as well as any combinations of such components. In some examples, control devices 104 may each be an equipment interface module (EIM).

Control devices 104 may provide networks 110A-110C (“networks 110”) to which devices may connect in order to communicate with control devices 104 to control building control units 108. In some examples, each of networks 110A-110C may be a wired network or a wireless network, such as an Ethernet network, a Wi-Fi network, a Bluetooth network, a cellular-based network, and the like.

Host devices 102A-102C (“host devices 102”) are computing devices configured to communicate with control devices 104 to control building control units 108. For example, host device 102A may communicate with control device 104A via network 110A to control building control units 108A, host device 102B may communicate with control device 104B via network 110B to control building control units 108B, and host device 102C may communicate with control device 104C via network 110C to control building control units 108C.

Host devices 102 may be any hardware or computing device for communicating with control devices 104 to control building control units 108, such as a HVAC controller, thermostat device, a smart home panel, an alarm system panel, a smart lighting switch, a smart home gateway device, and the like. For example, if building control unit 108A of a building is a HVAC unit, host device 102A may be a thermostat device that communicates with control device 104A to control the comfort level (e.g., temperature and/or humidity) in a building by activating and deactivating HVAC components of building control unit 108A in a controlled manner. Examples of host devices 102 include any one or more microprocessors, DSPs, ASICs, FPGAs, or any other equivalent integrated or discrete logic circuitry, as well as any combinations of such components. When host devices 102 includes software or firmware, host devices 102 may further include any necessary hardware for storing and executing the software or firmware, such as one or more processors or processing units. In general, a processing unit may include one or more microprocessors, DSPs, ASICs, FPGAS, or any other equivalent integrated or discrete logic circuitry, as well as any combinations of such components.

Client devices 112A-112C (“client devices 112”) may enroll in networks 110 to communicate with host devices 102 to provide data that host device 102 may use to control the operations of building control units 108. In the example of FIG. 1, one or more client devices 112A may enroll in network 110A, one or more client devices 112B may enroll in network 110B, and one or more client devices 112C may enroll in network 110C.

Client devices 112 may be built into host devices 102 and/or may be separate devices from host devices 102. Examples of client devices 112 may include one or more of a temperature sensor, an outdoor sensor, a humidity sensor, a humidity sensor, an occupancy sensor, a light sensor, a current sensor, a smoke sensor, and the like. In some examples, client devices 112 may include one or more internet gateway devices for connecting networks 110 to the Internet.

Host devices 102 of different networks 110 may not be capable of directly communicating with each other. For example, host device 102A of network 110A may not be capable of directly connecting to network 110B or network 110C to communicate with host device 102B or host device 102C. This may be because host devices of a network may be outside of the wireless communications range of other networks. For example, host device 102A of network 110A may not be capable of directly connecting to network 110B or network 110C because host device 102A is outside the wireless communications range of networks 110B and 110C.

Intermediate client devices are client devices that are capable of enrolling in more than one network of networks 110. By enrolling in two or more networks, such an intermediate client device may be able to communicate with two or more of host devices 102 and to control two or more of building control units 108. For example, an outdoor sensor may be capable of enrolling in two or more networks to communicate with host devices that control two different HVAC units. Examples an intermediate client device may include a temperature sensor, an outdoor sensor, a humidity sensor, a humidity sensor, an occupancy sensor, a light sensor, a current sensor, a smoke sensor, an internet gateway device for connecting networks 110 to the Internet, and the like.

In the example of FIG. 1, system 100 may include intermediate client devices 106A and 106B that are each capable of enrolling in two or more of networks 110. Intermediate client devices 106A and 106B are each capable of enrolling in networks 110A-110C to communicate with host devices 102A-102C. For example, each of intermediate client devices 106A and 106B may include multiple network interfaces, such as multiple wireless networking interfaces, that enable each of client devices 106A and 106B to connect to and enroll in two or more of networks 110A-110C. In some examples, intermediate client devices 106A and 106B may each be physically situated such that one or both of intermediate client devices 106A or 106B are within range of two or more of networks 110A-110C. For example, if intermediate client device 106A is physically situated within wireless communications range of networks 110A and 110B, intermediate client device 106A may be able to enroll into both networks 110A and 110B.

Host devices 102 may use an inter-network encryption key to encrypt inter-network communications between host devices 102 of different networks 110. In some examples, each of host devices 102 may be pre-programmed, such as at the factory or during initial setup of the host device, with an inter-network encryption key. As such, each of host devices 102 may not necessarily be programmed with the same inter-network encryption key, and there is no guarantee that a piece of data encrypted by one host device using the host device's pre-programmed inter-network encryption key can be decrypted by another host device using the other host devices pre-programmed inter-network security key.

In accordance with aspects of the present disclosure, host devices 102 may use intermediate client devices to distribute an inter-network encryption key across host devices 102 of networks 110, so that different host devices 102 on different networks 110 may use the same inter-network encryption key to securely communicate with each other.

When an intermediate client device enrolls in a network, the intermediate client device may send, to the host device in the network, an indication of whether the intermediate client device is already enrolled in another network. The indication of whether the intermediate client device is already enrolled in another network may either be a pre-defined value indicating that the intermediate client device is not already enrolled in another network or a candidate inter-network encryption key.

In the example of FIG. 1, intermediate client device 106A may enroll in network 110A and intermediate client device 106B may enroll in network 110A. Because neither of intermediate client devices 106A and 106B is already enrolled in another network prior to enrolling in respective networks 110A and 110B, intermediate client device 106A may send, to host device 102A, a pre-defined value indicating that intermediate client device 106A is not already enrolled in another network, and intermediate client device 106B may send, to host device 102B, a pre-defined value indicating that intermediate client device 106B is not already enrolled in another network.

The host device may receive, from the intermediate client device, the indication of whether the intermediate client device is already enrolled in another network, and may determine whether the indication of whether the intermediate client device is already enrolled in another network is a pre-defined value indicating that the intermediate client device is not already enrolled in another network or a candidate inter-network encryption key. If the host device determines that the indication of whether the intermediate client device is already enrolled in another network received from the intermediate client device is the pre-defined value indicating that the intermediate client device is not already enrolled in another network, the host device may send the inter-network encryption key of the host device to the intermediate client device.

In the example of FIG. 1, host device 102A may receive, from intermediate client device 106A, the pre-defined value indicating that intermediate client device 106A is not already enrolled in another network. Host device 102A may therefore determine, based on the data received from client device 106A, that intermediate client device 106A is not already enrolled in another network (e.g., network 110B or network 110C). In response to determining that intermediate client device 106A is not already enrolled in another network, host device 102A may send, to intermediate client device 106A, the inter-network encryption key of host device 102A, and intermediate client device 106A may set the inter-network encryption key of intermediate client device 106A to be the inter-network encryption key received from host device 102A. Host device 102A may therefore complete enrollment of intermediate client device 106A in network 110A

Similarly, host device 102B may receive, from intermediate client device 106B, the pre-defined value indicating that intermediate client device 106B is not already enrolled in another network. Host device 102B may therefore determine, based on the data received from client device 106B, that intermediate client device 106B is not already enrolled in another network (e.g., network 110A or network 110C). In response to determining that intermediate client device 106B is not already enrolled in another network, host device 102B may send, to intermediate client device 106B, the inter-network encryption key of host device 102B, and intermediate client device 106B may set the inter-network encryption key of intermediate client device 106B to be the inter-network encryption key received from host device 102B. Host device 102B may therefore complete enrollment of intermediate client device 106B in network 110B.

If the host device determines that the indication of whether the intermediate client device is already enrolled in another network received from the intermediate client device is a candidate inter-network encryption key, the host device may determine that the intermediate client is already enrolled in another network. The host device may, in response to receiving the candidate inter-network encryption key, determine whether any other intermediate client devices are already enrolled in the network. If the host device determines that no other intermediate client device is already enrolled in the network, the host device may determine that the inter-network encryption key of the host device is the pre-programmed inter-network security key. As such, the host device may set the inter-network encryption key to be the candidate inter-network encryption key received from the intermediate client device.

In the example of FIG. 1, after intermediate client device 106A is enrolled in network 110A and client device 106B is enrolled in network 110B, intermediate client device 106B may attempt to enroll in network 110B. Because intermediate client device 106B is already enrolled in network 110B, intermediate client device 106B may, as part of enrolling in network 110A, send the inter-network encryption key of intermediate client device 106B to host device 102A as a candidate inter-network encryption key.

If the host device, in response to receiving the candidate inter-network encryption key, determines that another intermediate client device is already enrolled in the network, the host device may send the inter-network encryption key of the host device to the intermediate client device that is enrolling in the network. The intermediate client device may, in response to receiving the inter-network encryption key from the host device, determine whether the inter-network encryption key received from the host device is the same as the inter-network encryption key of the intermediate client device. If intermediate client device determines that the inter-network encryption key received from the host device is not the same as the inter-network encryption key of the intermediate client device, the intermediate client device may broadcast the inter-network encryption key received from the host device to the host devices of other networks so that all host devices across different networks use the same inter-network encryption key.

In the example of FIG. 1, host device 102A may receive the candidate inter-network encryption key from intermediate client device 106B and may, in response, determine that intermediate client device 106A is already enrolled in network 110A. Host device 102A may, in response to determining that intermediate client device 106A is already enrolled in network 110A, send the inter-network encryption key of host device 102A to intermediate client device 106B.

Intermediate client device 106B may, in response to receiving the inter-network encryption key from host device 102A, determine whether the inter-network encryption key received from host device 102A is the same as the inter-network encryption key of intermediate client device 106B. If intermediate client device 106B determines that the inter-network encryption key received from host device 102A is not the same as the inter-network encryption key of intermediate client device 106B, intermediate client device 106B may set the inter-network encryption key of intermediate client device 106B to be the inter-network encryption key received from host device 102B, and may broadcast the inter-network encryption key received from host device 102B to the host devices 102B and 102C of other networks 110B and 110C. In some examples, host device 102A may broadcast the inter-network encryption key to the host devices 102B and 102C of other networks 110B and 110C.

Host devices 102B and 102C may each, in response to receiving the inter-network encryption key broadcasted by intermediate client device 106B, set its inter-network encryption key to the inter-network encryption key broadcasted by intermediate client device 106B. In this way, an intermediate client device, such as intermediate client device 106B, may distribute an inter-network encryption key amongst host devices 102B and 102C of networks 110B and 110C, so that each of host devices 102A, 102B, and 102C of networks 110A, 110B, and 110C may use the same inter-network encryption key for secure communications across networks 110.

Host devices 102A-102C may therefore use the same inter-network encryption key to securely communicate with each other across networks 110. For example, host device 102A may use its inter-network encryption key to encrypt a message and may send the message via wireless communications to host device 102B. Because host devices 102A-102C use the same inter-network encryption key to securely communicate with each other across networks 110, host device 102B may be able to successfully decrypt the secure message received from host device 102A using host device 102B's inter-network encryption key.

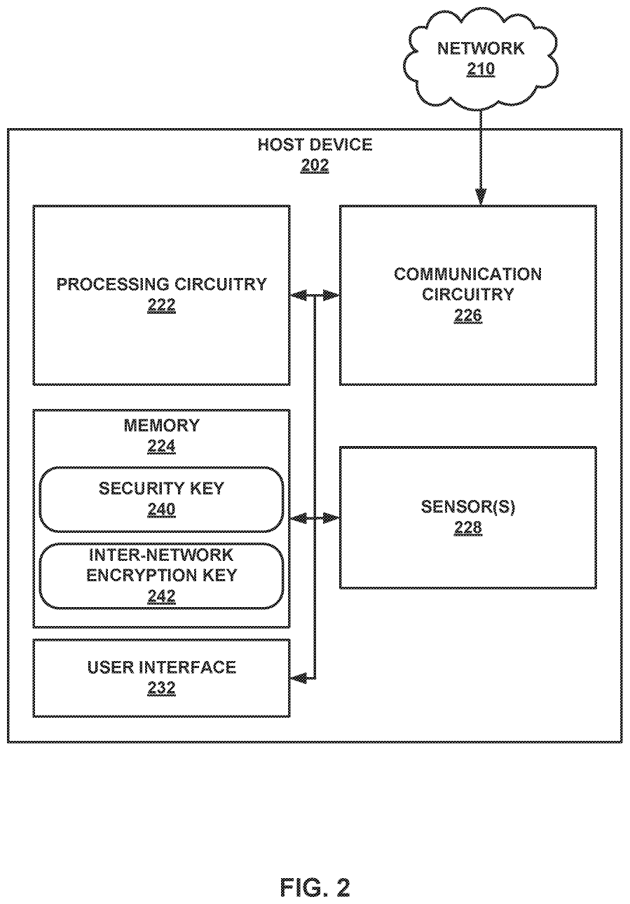

FIG. 2 is a block diagram illustrating an example host device 202, in accordance with one or more techniques described herein. Host device 202 may be an example of any of host devices 102. As shown in FIG. 2, host device 202 may be a thermostat device that includes processing circuitry 222, memory 224, communication circuitry 226, one or more sensors 228, and user interface 232. Host device 202 may be configured to connect, via communication circuitry 226, to a network, such as network 210, and to communicate, via communication circuitry 226, with client devices, such as client devices 112A-112C of FIG. 1 and with intermediate client devices, such as intermediate client devices 106A and 106B of FIG. 1.

Processing circuitry 222 may include fixed function circuitry and/or programmable processing circuitry. Processing circuitry 222 may include any one or more of a microprocessor, a controller, a DSP, an ASIC, an FPGA, or equivalent discrete or analog logic circuitry. In some examples, processing circuitry 222 may include multiple components, such as any combination of one or more microprocessors, one or more controllers, one or more DSPs, one or more ASICs, or one or more FPGAs, as well as other discrete or integrated logic circuitry. The functions attributed to processing circuitry 222 herein may be embodied as software, firmware, hardware or any combination thereof.

In some examples, memory 224 includes computer-readable instructions that, when executed by processing circuitry 222, cause Host device 202 and processing circuitry 222 to perform various functions attributed to Host device 202 and processing circuitry 222 herein. Memory 224 may include any volatile, non-volatile, magnetic, optical, or electrical media, such as random-access memory (RAM), read-only memory (ROM), non-volatile random-access memory (NVRAM), electrically erasable programmable read-only memory (EEPROM), flash memory, or any other digital media.

Communication circuitry 226 may include any suitable hardware, firmware, software or any combination thereof for communicating with client devices, including intermediate client devices, and to connect to network 210. Under the control of processing circuitry 222, communication circuitry 226 may receive downlink telemetry from, as well as send uplink telemetry to, devices connected to network 210 with the aid of an internal or external antenna. Communication circuitry 226 may include a Bluetooth transmitter and receiver, a Wi-Fi transmitter and receiver, a Zigbee transceiver, a near-field communication transceiver, or other circuitry configured to allow host device 202 to communicate with one or more remote devices to exchange data. Examples of exchanged data include a desired temperature for the space, one or more control parameters for a building control unit, error codes, geographic location, estimated energy usage and cost, and/or other operating parameters or system performance characteristics for a building control unit.

In some examples, host device 202 includes one or more sensors 228 including temperature sensors, proximity sensors, and the like. host device 202 may output the information sensed by sensors 228 at user interface 232 and/or use such information sensed by sensors 228 to control a building control unit.

User interface 232 may include one or more input components and one or more output components. Examples of one or more input components and one or more output components include one or more physical buttons, one or more touch-sensitive buttons, a touchscreen, a presence-sensitive display, a digital display, a mechanical dial, a microphone, a speaker, and the like.

In accordance with aspects of the present disclosure, processing circuitry 222 may be configured to enroll intermediate client devices in network 210 and to securely communicate with other network devices of other networks using an inter-network encryption key. Host device 202 may be pre-programmed, such as at a factory or during an initial setup process, with security key 240 and inter-network encryption key 242. Each of security key 240 and inter-network encryption key 242 may be a cryptographic key for encrypting and decrypting data. For example, each of security key 240 and inter-network encryption key 242 may be a symmetric encryption key that can be used to both encrypt and decrypt data. Security key 240 may be an encryption key for encrypting and decrypting data sent to and received from client devices enrolled in network 210, while inter-network encryption key 242 may be used to encrypt and decrypt data sent to and received from host devices on other networks (i.e., a network other than network 210).

Processing circuitry 222 may be configured to receive, via communication circuitry 226, a request from an intermediate client device to enroll in network 210. Processing circuitry 222 may, in response to receiving the request from the intermediate client device to enroll in network 210, process the request to enroll the intermediate client device into network 210. To enroll the intermediate client device into network 210, processing circuitry 222 may send security key 240 to the intermediate client device via communication circuitry 226. Processing circuitry 222 may also store, in memory 224, an indication that the intermediate client device is enrolled in network 210.

Processing circuitry 222 may, in response to receiving the request from the intermediate client device to enroll in network 210, determine whether the intermediate client device is the first intermediate client device to enroll in network 210 or if other intermediate client devices are already enrolled in network 210. For example, processing circuitry 222 may be configured to determine whether memory 224 stores an indication of another intermediate client devices that is already enrolled in network 210.

If processing circuitry 222 determines that the intermediate client device is not the first intermediate client device to enroll in network 210 because at least one other intermediate client device has already previously enrolled in network 210, processing circuitry 22 may be configured to send, via communication circuitry 226, inter-network encryption key 242 to the intermediate client device. For example, because processing circuitry 222 has already sent security key 240 to the intermediate client device, processing circuitry 222 may be configured to encrypt inter-network encryption key 242 using security key 240 and may send the encrypted inter-network encryption key 242 to the intermediate client device via communication circuitry 226.

In some examples, the request from the intermediate client device may, in some examples, include an indication of whether the intermediate client device is already enrolled in another network (i.e., a network other than network 210). If processing circuitry 222 determines that the intermediate client device is the first intermediate client device to enroll in network 210 because no other intermediate client device is already enrolled in network 210, processing circuitry 222 may be configured to determine, based at least in part on the indication of whether the intermediate client device is already enrolled in another network, whether the intermediate client device is already enrolled in another network.

For example, if the indication of whether the intermediate client device is already enrolled in another network includes an indication of a candidate inter-network encryption key, processing circuitry 222 may be configured to determine that the intermediate client device is already enrolled in another network and may be configured to set the candidate inter-network encryption key as inter-network encryption key 242. That is, processing circuitry 222 may update the value of inter-network encryption key 242 in memory 224 to be the value of the candidate inter-network encryption key.

In some examples, if the indication of whether the intermediate client device is already enrolled in another network indicates that the intermediate client device is not already enrolled in another network, processing circuitry 222 may be configured to send, via communication circuitry 226, inter-network encryption key 242 to the intermediate client device. For example, because processing circuitry 222 has already sent security key 240 to the intermediate client device, processing circuitry 222 may be configured to encrypt inter-network encryption key 242 using security key 240 and may send the encrypted inter-network encryption key 242 to the intermediate client device via communication circuitry 226.

In some examples, processing circuitry 222 may be configured to receive, via communication circuitry 226, a broadcast of an inter-network encryption key from an intermediate client device and may be configured to update inter-network encryption key 242 of host device 202 based on the broadcasted inter-network encryption key. Processing circuitry 222 may be configured to, in response to receiving a broadcast of an inter-network encryption key from an intermediate client device, attempt to decrypt the broadcasted inter-network encryption key using inter-network encryption key 242. If processing circuitry 222 is able to successfully decrypt the broadcasted inter-network encryption key using inter-network encryption key 242, processing circuitry 222 may be configured to set the broadcasted inter-network encryption key as inter-network encryption key 242, such as by setting the values of inter-network encryption key 242 to the values of the broadcasted inter-network encryption key.

Processing circuitry 222 may be configured to use inter-network encryption key 242 of host device 202 to send an encrypted message to a destination host device on another network outside of network 210. To send a data to a destination host device on another network outside of network 210, processing circuitry 222 may be configured to encrypt a message using inter-network encryption key 242 and to send, via communication circuitry 226, the encrypted message to the destination host device. Similarly, processing circuitry 222 may be configured to receive an encrypted message from another host device on another network. Processing circuitry 222 may be configured to use inter-network encryption key 242 to decrypt the message.

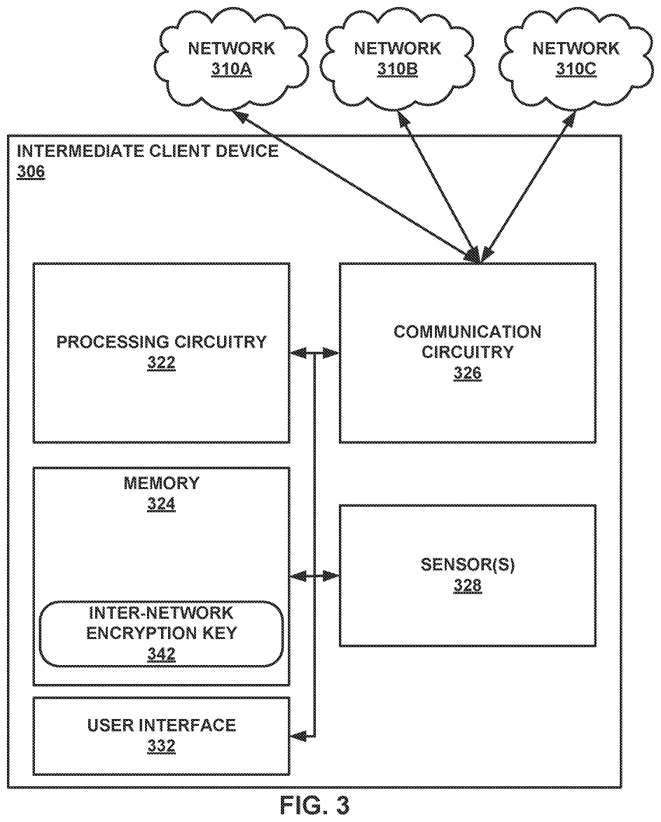

FIG. 3 is a block diagram illustrating an example intermediate client device 306, in accordance with one or more techniques described herein. Intermediate client device 306 may be an example of any of intermediate client devices 106A and 106B of FIG. 1. As shown in FIG. 2, intermediate client device 306 may be any device that is capable of connecting to multiple different networks and that includes processing circuitry 322, memory 324, communication circuitry 326, one or more sensors 328, and user interface 332. Intermediate client device 306 may be configured to connect, via communication circuitry 326, to a plurality of networks, such as networks 310A-310C, to communicate with the host devices of the plurality of networks.

Processing circuitry 322 may include fixed function circuitry and/or programmable processing circuitry. Processing circuitry 322 may include any one or more of a microprocessor, a controller, a DSP, an ASIC, an FPGA, or equivalent discrete or analog logic circuitry. In some examples, processing circuitry 322 may include multiple components, such as any combination of one or more microprocessors, one or more controllers, one or more DSPs, one or more ASICs, or one or more FPGAs, as well as other discrete or integrated logic circuitry. The functions attributed to processing circuitry 322 herein may be embodied as software, firmware, hardware or any combination thereof.

In some examples, memory 324 includes computer-readable instructions that, when executed by processing circuitry 322, cause intermediate client device 306 and processing circuitry 322 to perform various functions attributed intermediate client device 306 and processing circuitry 322 herein. Memory 324 may include any volatile, non-volatile, magnetic, optical, or electrical media, such as RAM, ROM, NVRAM, EEPROM, flash memory, or any other digital media.

Communication circuitry 326 may include any suitable hardware, firmware, software or any combination thereof for communicating with client devices, including intermediate client devices, and to connect to networks 310A-310C. Under the control of processing circuitry 322, communication circuitry 326 may receive downlink data from, as well as send uplink data to, host devices connected to any of networks 310A-310C with the aid of an internal or external antenna. Communication circuitry 326 may include a Bluetooth transmitter and receiver, a Wi-Fi transmitter and receiver, a Zigbee transceiver, a near-field communication transceiver, or other circuitry configured to allow host device 202 to communicate with one or more remote devices to exchange data. In some examples, communication circuitry 326 may include a plurality of network interfaces, such as wireless networking interfaces, to connect to a plurality of different networks, such as to connect to each of networks 310A-310C.

In some examples, intermediate client device 306 includes one or more sensors 328. One or more sensors 328 may include including a temperature sensor, an outdoor sensor, a humidity sensor, a humidity sensor, an occupancy sensor, a light sensor, a current sensor, a smoke sensor, a proximity sensor, and the like.

User interface 332 may include one or more input components and one or more output components. Examples of one or more input components and one or more output components include one or more physical buttons, one or more touch-sensitive buttons, a touchscreen, a presence-sensitive display, a digital display, a mechanical dial, a microphone, a speaker, and the like.

In accordance with aspects of the present disclosure, processing circuitry 322 may be configured to enroll intermediate client device 306 into two or more of networks 310A-310C. When intermediate client device 306 is not enrolled in any network, processing circuitry 322 may be configured to enroll intermediate client device 306 into network 310A by sending, via communication circuitry 326, a request to a host device of network 310A to enroll intermediate client device 306 into network 310A. The request may include an indication that intermediate client device 306 is not enrolled in any network. In response, processing circuitry 322 may receive, via communication circuitry 326, a security key for network 310A and an inter-network encryption key from the host device of network 310A. Processing circuitry 322 may be configured to store the security key for network 310A in memory 324 and to store the inter-network encryption key from the host device of network 310A as inter-network encryption key 342 in memory 324.

Processing circuitry 322 may be configured to, after enrolling intermediate client device 306 into network 310A, enroll intermediate client device 306 into network 310B by sending, via communication circuitry 326, a request to a host device of network 310B to enroll intermediate client device 306 into network 310B. The request may include an indication of inter-network encryption key 342. In response, processing circuitry 322 may receive, via communication circuitry 326, a security key for network 310B, and processing circuitry 322 may be configured to store the security key for network 310B in memory 324. If intermediate client device 306 is the first intermediate client device enrolled in network 310B, the host device of network 310B may accept inter-network encryption key 342 of intermediate client device 306 as the inter-network encryption key of the host device of network 310B.

Processing circuitry 322 may be configured to, after enrolling intermediate client device 306 into networks 310A and 310B, enroll intermediate client device 306 into network 310C by sending, via communication circuitry 326, a request to a host device of network 310C to enroll intermediate client device 306 into network 310C. The request may include an indication of inter-network encryption key 342. In response, processing circuitry 322 may receive, via communication circuitry 326, a security key for network 310C. If intermediate client device 306 is not the first intermediate client device enrolled in network 310C, the host device of network 310C may, in response, send an inter-network encryption key of the host device of network 310C to intermediate client device 306.

Processing circuitry 322 may be configured to receive, via communication circuitry 326, an inter-network encryption key of the host device of network 310C sent by the host device of network 310C. For example, processing circuitry 322 may be configured to receive, via communication circuitry 326, an inter-network encryption key of the host device of network 310C that is encrypted using the security key for network 310C. Processing circuitry 322 may therefore retrieve, from memory 324, the security key for network 310C and may decrypt the inter-network encryption key of the host device of network 310C using the security key for network 310C.

Processing circuitry 322 may be configured to compare the inter-network encryption key of the host device of network 310C with inter-network encryption key 342 stored in memory 324. If processing circuitry 322 determines that the inter-network encryption key of the host device of network 310C does not match inter-network encryption key 342 stored in memory 324, processing circuitry 322 may be configured to broadcast, via communication circuitry 326, the inter-network encryption key of the host device of network 310C to a plurality of networks, such as by wirelessly broadcasting a signal that indicates the inter-network encryption key of the host device of network 310C.

In some examples, processing circuitry 322 may be configured to encrypt, using inter-network encryption key 342, the inter-network encryption key of the host device of network 310C, and may broadcast the encrypted inter-network encryption key of the host device of network 310C. Processing circuitry 322 may also set the inter-network encryption key of the host device of network 310C as inter-network encryption key 342, such as by setting the values of inter-network encryption key 342 to the values of the inter-network encryption key of the host device of network 310C.

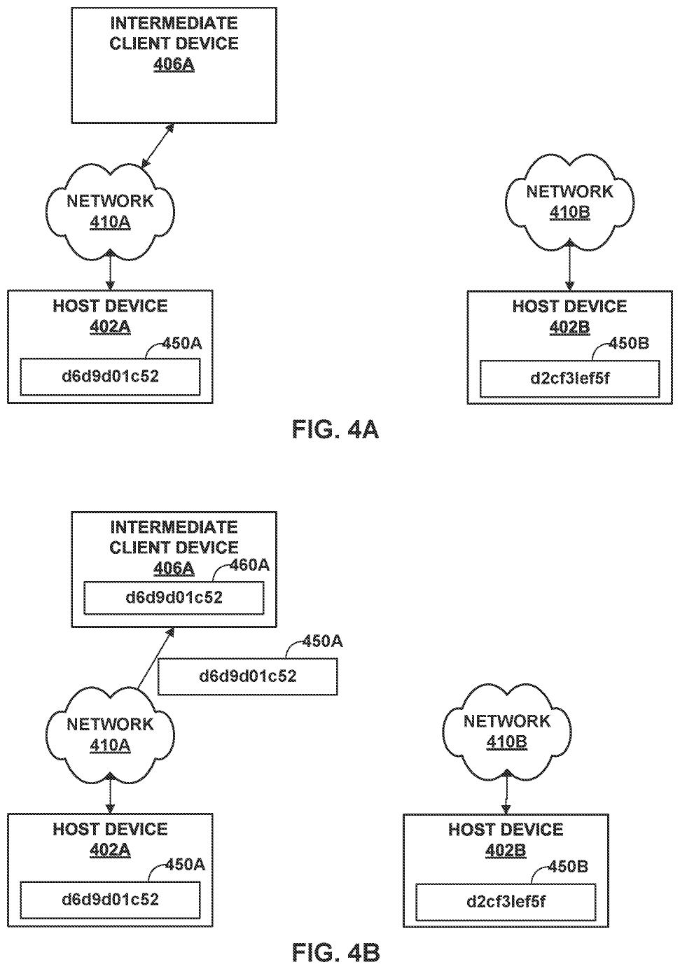

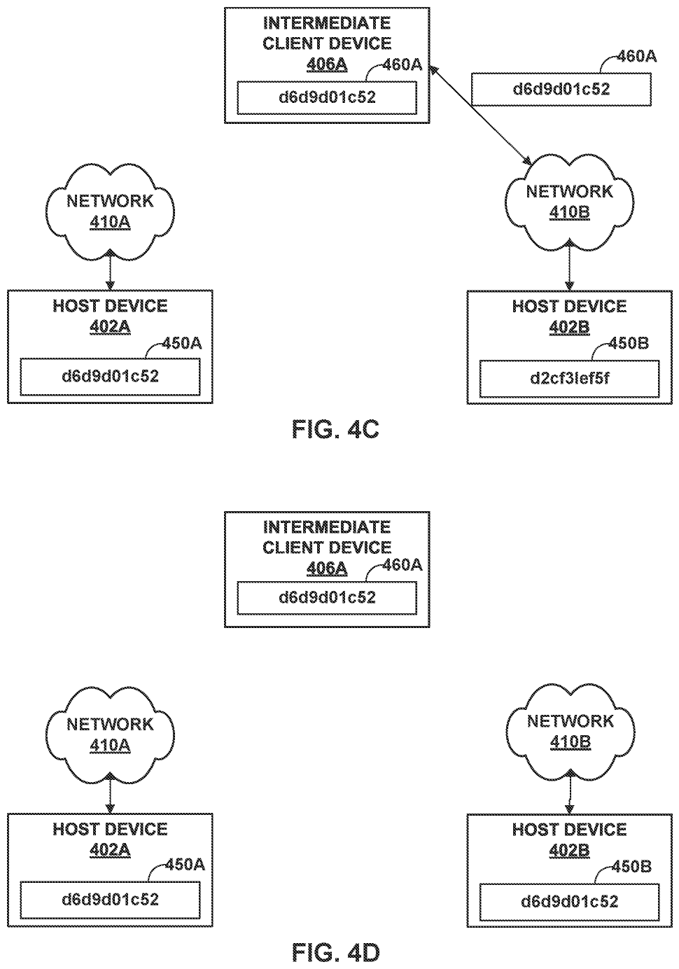

FIGS. 4A-4D are block diagrams illustrating an example technique for exchanging inter-network encryption keys between host devices, in accordance with aspects of the present disclosure. As shown in FIGS. 4A-4D, host devices 402A and 402B are examples of any of host devices 102 of FIG. 1; networks 410A and 410B are examples of any of networks 110 of FIG. 1; and intermediate client device 406A is an example of any of intermediate client devices 106 of FIG. 1.

In the example of FIG. 4A, prior to any intermediate client devices being enrolled in networks 410A and 410B, host device 402A in network 410A may store inter-network encryption key 450A of “d6d9d01c52” for network 410A that is pre-programmed into host device 402A, and host device 402B in network 410B may store inter-network encryption key 450B of “d2cf31ef5f” for network 410B that is pre-programmed into host device 402B.

Intermediate client device 406A has not been enrolled in any network when intermediate client device 406A enrolls in network 410B. As such, intermediate client device 406A may send, to host device 402A, a request to enroll in network 410A that includes an indication that intermediate client device 406A is not enrolled in any network.

As shown in FIG. 4B, host device 402A may receive the request to enroll in network 410A from intermediate client device 406A, including receiving the indication that intermediate client device 406A is not enrolled in any network. Host device 402A may send a security key for network 410A to intermediate client device 406A so that client device 406A may securely communicate with host device 402A.

Host device 402A may determine, based on the indication that intermediate client device 406A is not enrolled in any network, that intermediate client device 406A is not enrolled in any network. Host device 402A may, in response to determining that intermediate client device 406A is not enrolled in any network, send inter-network encryption key 450A of “d6d9d01c52” for network 410A to intermediate client device 406A. For example, host device 402A may encrypt inter-network encryption key 450A using the security key for network 410A and may send the encrypted inter-network encryption key 450A to intermediate client device 406A.

Intermediate client device 406A may receive the encrypted inter-network encryption key 450A and may decrypt the encrypted inter-network encryption key 450A using the security key for network 410A. Intermediate client device 406A may therefore store inter-network encryption key 450A received from host device 402A as inter-network encryption key 460A for intermediate client device 406A.

As shown in FIG. 4C, intermediate client device 406A may send, to host device 402B, a request to enroll in network 410A that includes an indication of inter-network encryption key 460A for intermediate client device 406A. The indication of inter-network encryption key 460A for intermediate client device 406A indicates that intermediate client device 406A is already enrolled in another network.

As shown in FIG. 4D, host device 402B may receive the request to enroll in network 410B from intermediate client device 406A, including receiving the indication of inter-network encryption key 460A for intermediate client device 406A. Host device 402B may send a security key for network 410B to intermediate client device 406A so that client device 406A may securely communicate with host device 402B. Host device 402A may also, in response to receiving the indication of inter-network encryption key 460A for intermediate client device 406A, whether any other intermediate client devices is already enrolled in network 410B. Host device 402A may, in response to determining that no other intermediate client device is already enrolled in network 410B, update inter-network encryption key 450B of network 410B by setting inter-network encryption key 460A for intermediate client device 406A received from intermediate client device 406A as inter-network encryption key 450B of network 410B.

In this way, inter-network encryption key 450B of network 410B may be updated to have the same value (e.g., “d6d9d01c52”) as the same as inter-network encryption key 450A of network 410A, thereby enabling host device 402A and host device 402B to exchange data encrypted using inter-network encryption keys 450A and 450B. For example, because inter-network encryption key 450B of network 410B may have the same value as the same as inter-network encryption key 450A of network 410A, host device 402A may use inter-network encryption key 450A to encrypt a message and send the encrypted message to host device 402B, and host device 402B may use inter-network encryption key 450B to decrypt the encrypted message.

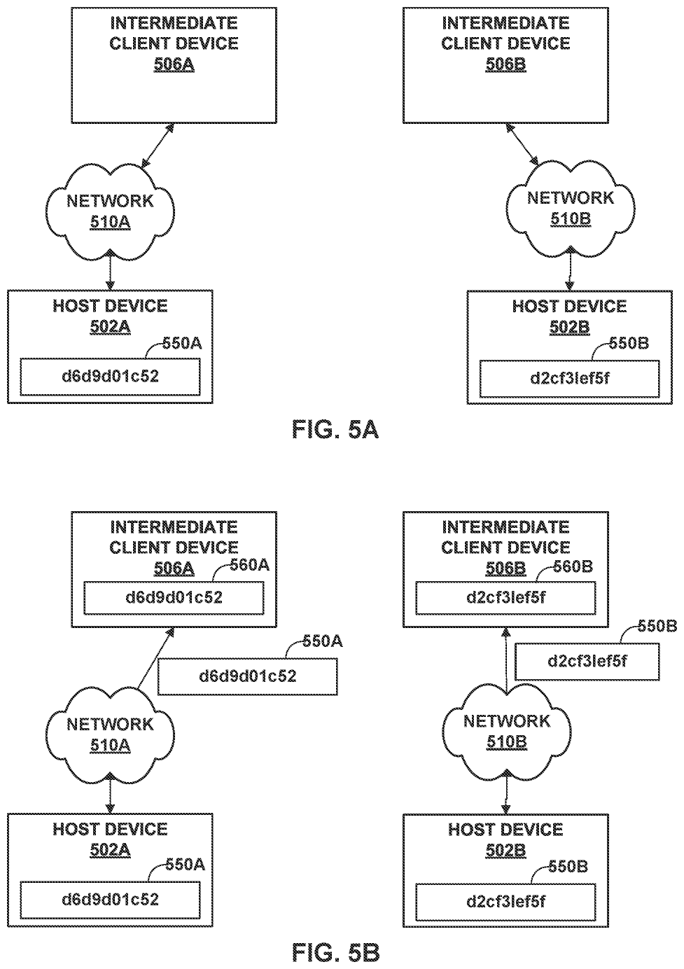

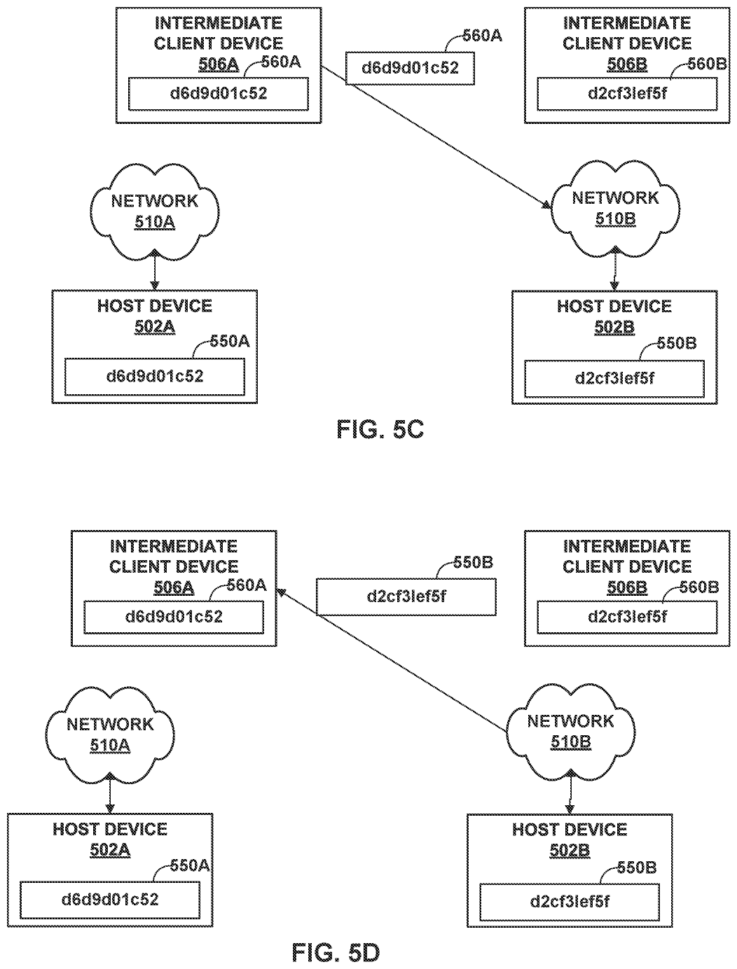

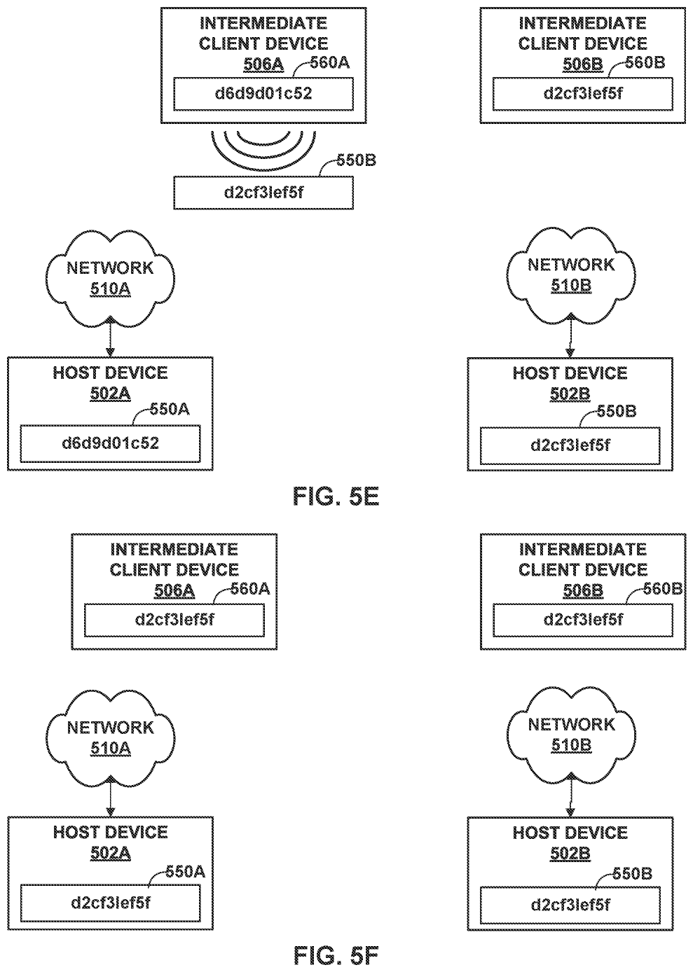

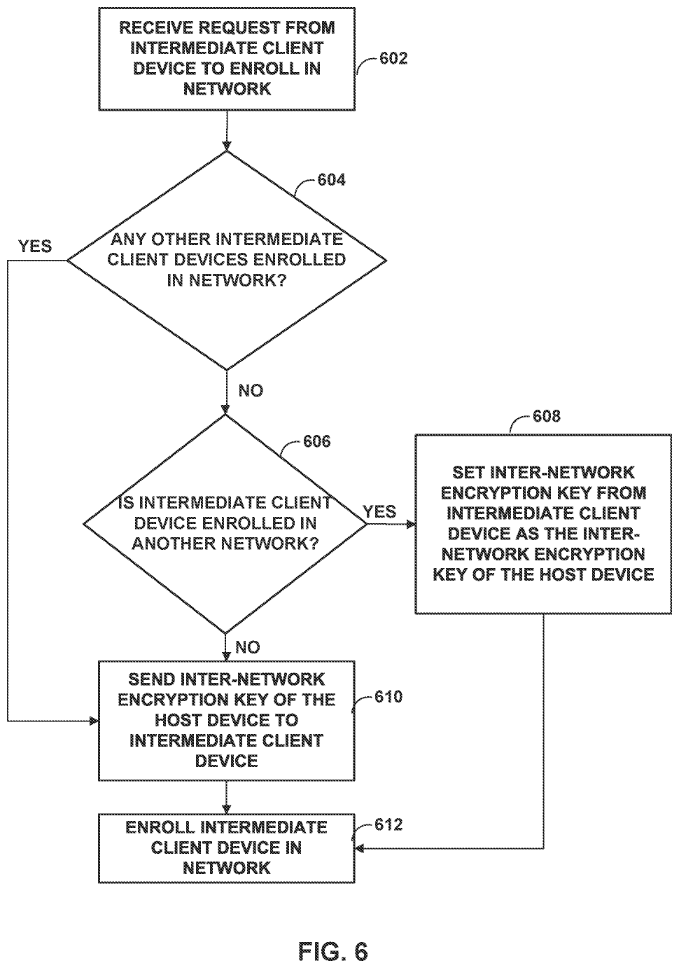

FIGS. 5A-5F are block diagrams illustrating an example technique for exchanging inter-network encryption keys between host devices, in accordance with aspects of the present disclosure. As shown in FIGS. 5A-5F, host devices 502A and 502B are examples of any of host devices 102 of FIG. 1, networks 510A and 510B are examples of any of networks 110 of FIG. 1, and intermediate client devices 506A and 506B are examples of intermediate client devices 106 of FIG. 1. In the example of FIG. 5A, prior to any intermediate client devices being enrolled in networks 510A and 510B, host device 502A in network 510A may store inter-network encryption key 550A of “d6d9d01c52” for network 510A that is pre-programmed into host device 502A, and host device 502B in network 510B may store inter-network encryption key 550B of “d2cf31ef5f” for network 510B that is pre-programmed into host device 502B.

Intermediate client device 506A may send, to host device 502A, a request to enroll in network 510A that includes an indication that intermediate client device 506A is not enrolled in any network. Similarly, intermediate client device 506B may send, to host device 502B, a request to enroll in network 510B that includes an indication that intermediate client device 506B is not enrolled in any network.

Host device 502A may receive the request to enroll in network 510A from intermediate client device 506A, including receiving the indication that intermediate client device 506A is not enrolled in any network. Host device 502A may send a security key for network 510A to intermediate client device 506A so that client device 506A may securely communicate with host device 502A. Similarly, host device 502B may receive the request to enroll in network 510B from intermediate client device 506B, including receiving the indication that intermediate client device 506B is not enrolled in any network. Host device 502B may send a security key for network 510B to intermediate client device 506B so that client device 506B may securely communicate with host device 502B.

As shown in FIG. 5B, host device 502A may determine, based on the indication that intermediate client device 506A is not enrolled in any network, that intermediate client device 506A is not enrolled in any network. Host device 502A may, in response to determining that intermediate client device 506A is not enrolled in any network, send inter-network encryption key 550A of “d6d9d01c52” for network 510A to intermediate client device 506A. For example, host device 502A may encrypt inter-network encryption key 550A using the security key for network 510A and may send the encrypted inter-network encryption key 550A to intermediate client device 506A.

Intermediate client device 506A may receive the encrypted inter-network encryption key 550A and may decrypt the encrypted inter-network encryption key 550A using the security key for network 510A. Intermediate client device 506A may therefore store inter-network encryption key 550A received from host device 502A as inter-network encryption key 560A for intermediate client device 506A.

Similarly, host device 502B may determine, based on the indication that intermediate client device 506B is not enrolled in any network, that intermediate client device 506B is not enrolled in any network. Host device 502B may, in response to determining that intermediate client device 506B is not enrolled in any network, send inter-network encryption key 550B of “d2cf31ef5f” for network 510B to intermediate client device 506B. For example, host device 502B may encrypt inter-network encryption key 550B using the security key for network 510B and may send the encrypted inter-network encryption key 550B to intermediate client device 506B.

Intermediate client device 506B may receive the encrypted inter-network encryption key 550B and may decrypt the encrypted inter-network encryption key 550B using the security key for network 510B. Intermediate client device 506B may therefore store inter-network encryption key 550B received from host device 502B as inter-network encryption key 560B for intermediate client device 506B.

As shown in FIG. 5C, after intermediate client device 506A is enrolled in network 510A and intermediate client device 506B is enrolled in network 510B, intermediate client device 506A may send a request to host device 502B to enroll in network 510B, including sending an indication of inter-network encryption key 560A of intermediate client device 506A to host device 502B of network 510B.

Host device 502B may receive the request to enroll in network 510B from intermediate client device 506B, including receiving the indication of inter-network encryption key 560A of intermediate client device 506A. Host device 502B may send a security key for network 510B to intermediate client device 506A so that client device 506A may securely communicate with host device 502B.

As shown in FIG. 5D, host device 502B may, in response to receiving the request to enroll in network 510B from intermediate client device 506A, determine that intermediate client device 506B is already enrolled in network 510B and may, in response, send an inter-network encryption key 550B of “d2cf31ef5f” for network 510B to intermediate client device 506A. For example, host device 502B may encrypt inter-network encryption key 550B and send the encrypted inter-network encryption key 550B to intermediate client device 506A.

Intermediate client device 506A may receive the encrypted inter-network encryption key 550B and may decrypt the encrypted inter-network encryption key 550B using the security key for network 510B. Intermediate client device 506A may compare inter-network encryption key 550B received with host device 502B with inter-network encryption key 560A stored in intermediate client device 506A to determine whether inter-network encryption key 550B matches (e.g., has the same value as) inter-network encryption key 560A stored in intermediate client device 506A.

As shown in FIG. 5E, if intermediate client device 506A determines that inter-network encryption key 550B received from host device 502B does not match (e.g., does not have the same value as) inter-network encryption key 560A stored in intermediate client device 506A, intermediate client device 506A may broadcast inter-network encryption key 550B received from host device 502B to other networks, such as network 510A. In some examples, to broadcast inter-network encryption key 550B, intermediate client device 506A may encrypt inter-network encryption key 550B using inter-network encryption key 560A stored in intermediate client device 506A, and may broadcast the encrypted inter-network encryption key 550B. By encrypting inter-network encryption key 550B using inter-network encryption key 560A, the broadcasted encrypted inter-network encryption key 550B may only be able to be decrypted by host devices that uses the same inter-network encryption key as inter-network encryption key 560A of intermediate client device 506A, thereby improving security of broadcasting inter-network encryption key 550B.

Host device 502A uses inter-network encryption key 550A of network 510A having the same value of “d6d9d01c52” as inter-network encryption key 560A of intermediate client device 506A. Thus, host device 502A may be able to receive the encrypted inter-network encryption key 550B broadcasted by intermediate client device 506A and may be able to decrypt encrypted inter-network encryption key 550B using inter-network encryption key 550A of network 510A. Host device 502A may store inter-network encryption key 550B as inter-network encryption key 550A of network 510A by setting the value of inter-network encryption key 550A of network 510A to the value of inter-network encryption key 550B. Intermediate client device 506A may also store inter-network encryption key 550B as inter-network encryption key 560A by setting the value of inter-network encryption key 560A of intermediate client device 506A to the value of inter-network encryption key 550B

In this way, inter-network encryption key 550A of network 510A may be updated to have the same value (e.g., “d2cf31ef5f”) as the same as inter-network encryption key 550B of network 510B, thereby enabling host device 502A and host device 502B to exchange data encrypted using inter-network encryption keys 550A and 550B. For example, because inter-network encryption key 550A of network 510A may have the same value as the same as inter-network encryption key 550A of network 510A, host device 502A may use inter-network encryption key 550A to encrypt a message and send the encrypted message to host device 502B, and host device 502B may use inter-network encryption key 550B to decrypt the encrypted message.

FIG. 6 is a flow diagram illustrating an example operation of a host device of a network for enrolling an intermediate client device in the network, in accordance with aspects of the present disclosure. The techniques described in FIG. 6 may be performed by a host device, such as any one of host devices 102A-102C of FIG. 1, host devices 402A and 402B of FIG. 4, host devices 502A and 502B of FIG. 5, and the like. The host device may enroll an intermediate client device, such as any one of intermediate client devices 106A and 106B of FIG. 1, intermediate client device 406A of FIG. 4, and intermediate client devices 506A and 506B of FIG. 5.

As shown in FIG. 6, a host device of a network may receive, from an intermediate client device, a request to enroll in the network (602). The host device may, in response to receiving the request to enroll in the network, determine whether any other intermediate client devices is already enrolled in the network (604). If the host device determines that another intermediate client device is already enrolled in the network, the host device may send the inter-network encryption key of the host device to the intermediate client device (610) and may enroll the intermediate client device in the network (612).

If the host device determines that no other intermediate client device is already enrolled in the network, the host device may determine whether the intermediate device is also enrolled in another network (606). The host device may determine whether the intermediate device is also enrolled in another network based on the request received from the intermediate client device to enroll in the network. For example, if the host device determines that the request includes an indication of an inter-network security key, the host device may determine that the intermediate device is also enrolled in another network.

If the host device determines that the intermediate client device is also enrolled in another network because the request includes an indication of an inter-network security key, the host device may set the inter-network security key received from the intermediate client device as the inter-network security key of the host device (608) and may enroll the intermediate client device in the network (612). If the host device determines that the intermediate client device is not also enrolled in another network because the request does not include an indication of an inter-network security key, the host device may send the inter-network security key of the host device to the intermediate client device (610) and may enroll the intermediate client device in the network (612).

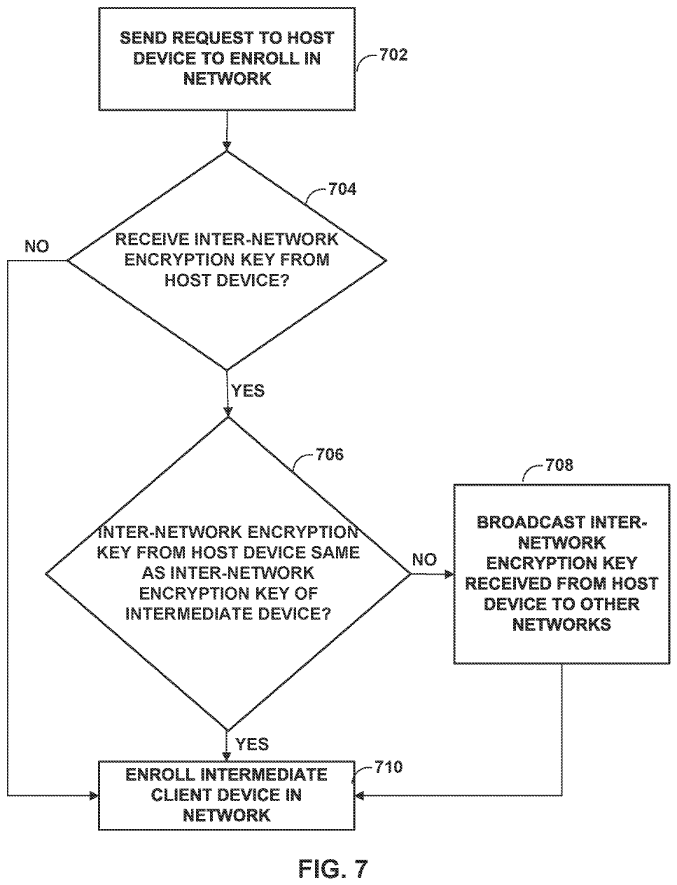

FIG. 7 is a flow diagram illustrating an example operation of an intermediate client device that enrolls in a network by communicating with a host device of the network, in accordance with aspects of the present disclosure. The techniques described in FIG. 7 may be performed by an intermediate client device, such as any one of intermediate client devices 106A and 106B of FIG. 1, intermediate client device 406A of FIG. 4, and intermediate client devices 506A and 506B of FIG. 5, that communicates with a host device, such as any one of host devices 102A-102C of FIG. 1, host devices 402A and 402B of FIG. 4, host devices 502A and 502B of FIG. 5, and the like.

As shown in FIG. 7, an intermediate client device may send a request to a host device of a network to enroll in the network (702). The request may include an indication of an inter-network encryption key of the intermediate client device, if the intermediate client device has already enrolled in another network, or may include an indication that the intermediate client device has not enrolled in another network.

The intermediate client device may, in response to sending the request to the host device to enroll in the network, determine whether an inter-network encryption key has been received from the host device (704). If the intermediate client device does not receive an inter-network encryption key from the host device, the intermediate client device may complete enrollment in the network (710).

If the intermediate client device receives an inter-network encryption key from the host device, the intermediate client device may determine whether the inter-network encryption key received from the host device matches the inter-network encryption key of the intermediate client device (706). If the intermediate client device determines that the inter-network encryption key received from the host device matches the inter-network encryption key of the intermediate client device, or if the intermediate client device does not have an inter-network encryption key of the intermediate client device, the intermediate client device may complete enrollment in the network (710).

If the intermediate client device determines that the inter-network encryption key received from the host device does not match the inter-network encryption key of the intermediate client device, the intermediate client device may broadcast the inter-network encryption key received from the host device to other networks (708). For example, the intermediate client device may encrypt the inter-network encryption key received from the host device with the inter-network encryption key of the intermediate client device and may broadcast the encrypted inter-network encryption key received from the host device to other networks. The intermediate client device may therefore complete enrollment in the network (710).

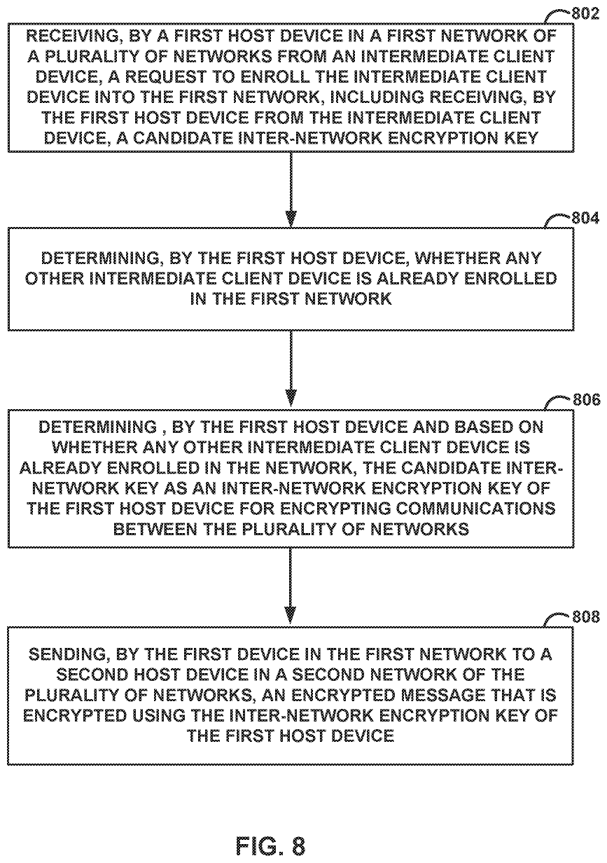

FIG. 8 is a flow diagram illustrating an example operation of a host device a network that enrolls an intermediate client device in the network, in accordance with aspects of the present disclosure. FIG. 8 is described with respect to host devices 102A and 102B, networks 110A and 110B, and intermediate client device 106A of FIG. 1. However, the techniques of FIG. 8 may be performed by additional or alternative devices.

As shown in FIG. 8, first host device 102A in a first network 110B may receive, from an intermediate client device 106A, a request to enroll the intermediate client device 106A into the first network 110A, including receiving, from the intermediate client device 106A, a candidate inter-network encryption key (802). First host device 102A may determine whether any other intermediate client device is already enrolled in the first network 110A (804). first host device 102A may, based on the determination of whether any other intermediate client device is already enrolled in the first network 110A, set the candidate inter-network encryption key as an inter-network encryption key of the first host device 102A for encrypting communications between the plurality of networks (e.g., encrypting communications across two or more networks) (806). First host device 102A in the first network 110A may send, to the intermediate client device 106A for forwarding to a second host device 102B in a second network 110B of the plurality of networks, an encrypted message that is encrypted using the inter-network encryption key of the first host device 102A (808).

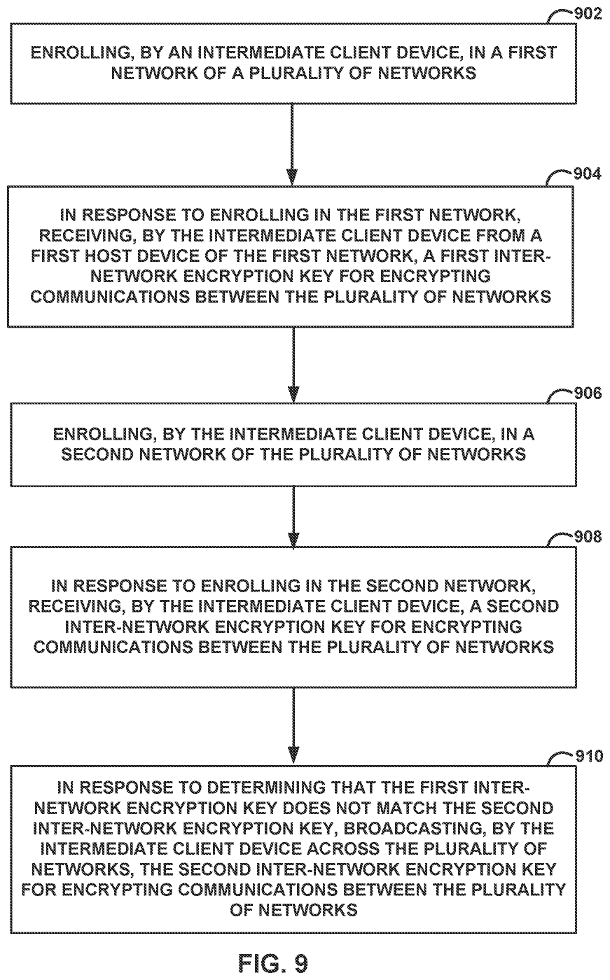

FIG. 9 is a flow diagram illustrating an example operation of an intermediate client device that may enroll in two or more networks, in accordance with aspects of the present disclosure. FIG. 9 is described with respect to host devices 102A and 102B, networks 110A and 110B, and intermediate client device 106A of FIG. 1. However, the techniques of FIG. 9 may be performed by additional or alternative devices.

As shown in FIG. 9, intermediate client device 106A may enroll in a first network 110A of a plurality of networks (902). Intermediate client device 106A may, in response to enrolling in the first network of the plurality of networks, receive, from a first host device 102A of the first network 110A, a first inter-network encryption key for encrypting communications between the plurality of networks (904).

Intermediate client device 106A may enroll in a second network 110B of the plurality of networks (906). Intermediate client device 106A may, in response to enrolling in the second network 110B, receive, from a second host device 102B of the second network 110B, a second inter-network encryption key for encrypting communications between the plurality of networks (908). Intermediate client device 106A may, in response to determining that the first inter-network encryption key does not match the second inter-network encryption key, broadcast, across the plurality of networks, the second inter-network encryption key for encrypting communications between the plurality of networks (910).

The disclosure may include the following examples.

Example 1: A method includes receiving, by a first host device in a first network of a plurality of networks and from an intermediate client device, a request to enroll the intermediate client device into the first network, including receiving, by the first host device from the intermediate client device, a candidate inter-network encryption key; determining, by the first host device, whether any other intermediate client device is already enrolled in the first network; in response to determining that no other intermediate client device is already enrolled in the first network, setting, by the first host device, the candidate inter-network encryption key as an inter-network encryption key of the first host device for encrypting communications between the plurality of networks; and sending, by the first host device in the first network to a second host device in a second network of the plurality of networks, an encrypted message that is encrypted using the inter-network encryption key of the first host device.

Example 2: The method of example 1, wherein receiving the request to enroll the intermediate client device into the first network further includes receiving, by the first host device and from the intermediate client device, a candidate inter-network encryption key; and wherein determining the inter-network encryption key of the first host device further includes in response to determining that no other intermediate client device is already enrolled in the first network, setting, by the first host device, the candidate inter-network encryption key as the inter-network encryption key of the first host device for encrypting communications between the plurality of networks.

Example 3: The method of any of examples 1 and 2, further includes after enrolling the intermediate client device into the first network, receiving, by the first host device from a second intermediate client device, a request to enroll the second intermediate client device into the first network; in response to receiving the request to enroll the second intermediate client device into the first network, determining, by the first host device in the first network, that the intermediate client device is already enrolled into the first network; and in response to determining that intermediate client device is already enrolled into the first network, sending, by the first host device to the second intermediate client device, the inter-network encryption key of the first host device for encrypting communications between the plurality of networks to enable the second intermediate client device.

Example 4: The method of example 3, further comprising in response to receiving the request to enroll the second intermediate client device into the first network, sending, by the first host device to the second intermediate client device, a security key for the host device, wherein sending, to the second intermediate client device, the inter-network encryption key of the first host device further comprises: encrypting, by the host device and using the security key of the host device, the inter-network encryption key to generate an encrypted inter-network encryption key of the first host device, and sending, by the first host device to the second intermediate client device, the encrypted inter-network encryption key of the first host device.

Example 5: The method of any of examples 1-4, wherein each of the plurality of networks is provided by a corresponding control device of a building control unit.

Example 6: The method of example 5, wherein: the first host device is connected to the first network provided by a first control device of a first heating, ventilation, and air conditioning (HVAC) unit; and the second host device is connected to the second network provided by a second control device of a second HVAC unit.

Example 7: The method of any of examples 1-6, wherein the intermediate client device comprises one of: a temperature sensor, an outdoor sensor, a humidity sensor, an occupancy sensor, a light sensor, a current sensor, or a smoke sensor.

Example 8: A host device includes communication circuitry configured to connect to a first network of a plurality of networks; memory; processing circuitry operably coupled to the memory and communication circuitry and configured to: receive, from an intermediate client device via the communication circuitry, a request to enroll the intermediate client device into the first network; determine whether any other intermediate client device is already enrolled in the first network; determine, based on the determination of whether any other intermediate client device is already enrolled in the first network, the candidate inter-network encryption key as an inter-network encryption key of the host device for encrypting communications between the plurality of networks; and send, to the intermediate client device via the communication circuitry, an encrypted message that is encrypted using the inter-network encryption key of the host device for forwarding to a second host device in a second network of the plurality of networks.

Example 9. The host device of example 8, wherein to receive the request to enroll the intermediate client device into the first network, the processing circuitry is further configured to receive, from the intermediate client device, a candidate inter-network encryption key; and wherein to determine the inter-network encryption key of the first host device, the processing circuitry is further configured to, in response to determining that no other intermediate client device is already enrolled in the first network, set the candidate inter-network encryption key as the inter-network encryption key of the first host device for encrypting communications between the plurality of networks.

Example 10: The host device of example any of examples 8 and 9, wherein the processing circuitry is further configured to: after enrolling the intermediate client device into the first network, receive, from a second intermediate client device via the communication circuitry, a request to enroll the second intermediate client device into the first network; in response to receiving the request to enroll the second intermediate client device into the first network, determine that the intermediate client device is already enrolled into the first network; and in response to determining that intermediate client device is already enrolled into the first network, send, to the second intermediate client device via the communication circuitry, the inter-network encryption key of the host device for encrypting communications between the plurality of networks to enable the second intermediate client device.

Example 11: The host device of example 10, wherein the processing circuitry is further configured to: in response to receiving the request to enroll the second intermediate client device into the first network, send, to the second intermediate client device, a security key for the host device, wherein to send, to the second intermediate client device, the inter-network encryption key of the first host device, the processing circuitry is further configured to: encrypt, using the security key of the host device, the inter-network encryption key to generate an encrypted inter-network encryption key of the first host device, and send, to the second intermediate client device, the encrypted inter-network encryption key of the first host device.

Example 12: The host device of any of examples 8-11 wherein each of the plurality of networks is provided by a corresponding control device of a building control unit.

Example 13: The host device of example 12, wherein: the host device is connected to the first network provided by a first control device of a first heating, ventilation, and air conditioning (HVAC) unit; and the second host device is connected to the second network provided by a second control device of a second HVAC unit.

Example 14: The host device of any of examples 8-13, wherein the intermediate client device comprises one of: a temperature sensor, an outdoor sensor, a humidity sensor, an occupancy sensor, a light sensor, a current sensor, or a smoke sensor.

Example 15: A method includes enrolling, by an intermediate client device, in a first network of a plurality of networks receiving, by the intermediate client device from a first host device of the first network, a first inter-network encryption key for encrypting communications between the plurality of networks; enrolling, by the intermediate client device, in a second network of the plurality of networks receiving, by the intermediate client device from a second host device of the second network, a second inter-network encryption key for encrypting communications between the plurality of networks; and in response to determining that the first inter-network encryption key does not match the second inter-network encryption key, broadcasting, by the intermediate client device across the plurality of networks, the second inter-network encryption key for encrypting communications between the plurality of networks.

Example 16: The method of example 15, wherein broadcasting the second inter-network encryption key further includes: encrypting, by the intermediate client device using the first inter-network encryption key, the second inter-network encryption key to generate an encrypted inter-network encryption key; and broadcasting, by the intermediate client device across the plurality of networks, the encrypted inter-network encryption key.

Example 17: The method of any of examples 15 and 16, wherein receiving the first inter-network encryption key for encrypting communications between the plurality of networks further comprises: receiving, by the intermediate client device and from the first host device, a security key of the first network; receiving, by the intermediate client device and from the first host device, an encrypted first inter-network encryption key; and decrypting, by the intermediate client device and using the security key of the first network, the encrypted first inter-network encryption key to generate the first inter-network encryption key.

Example 18: The method of any of examples 15-17, wherein the plurality of networks comprise a plurality of wireless networks.

Example 19: The method of any of examples 15-18, wherein the intermediate client device comprises one of: a temperature sensor, an outdoor sensor, a humidity sensor, a humidity sensor, an occupancy sensor, a light sensor, a current sensor, or a smoke sensor.

Example 20: The method of any of examples 15-18, wherein the intermediate client device comprises an internet gateway device for connecting the first network and the second network to the Internet. The disclosure contemplates computer-readable storage media comprising instructions to cause a processor to perform any of the functions and techniques described herein. The computer-readable storage media may take the example form of any volatile, non-volatile, magnetic, optical, or electrical media, such as a RAM, ROM, NVRAM, EEPROM, or flash memory. The computer-readable storage media may be referred to as non-transitory. A computing device may also contain a more portable removable memory type to enable easy data transfer or offline data analysis.

The techniques described in this disclosure may be implemented, at least in part, in hardware, software, firmware or any combination thereof. For example, various aspects of the techniques may be implemented within one or more processors, including one or more microprocessors, DSPs, ASICs, FPGAs, or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry.

As used herein, the term “circuitry” refers to an ASIC, an electronic circuit, a processor (shared, dedicated, or group) and memory that execute one or more software or firmware programs, a combinational logic circuit, or other suitable components that provide the described functionality. The term “processing circuitry” refers one or more processors distributed across one or more devices. For example, “processing circuitry” can include a single processor or multiple processors on a device. “Processing circuitry” can also include processors on multiple devices, wherein the operations described herein may be distributed across the processors and devices.

Such hardware, software, firmware may be implemented within the same device or within separate devices to support the various operations and functions described in this disclosure. For example, any of the techniques or processes described herein may be performed within one device or at least partially distributed amongst two or more devices. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components, or integrated within common or separate hardware or software components.

The techniques described in this disclosure may also be embodied or encoded in an article of manufacture including a non-transitory computer-readable storage medium encoded with instructions. Instructions embedded or encoded in an article of manufacture including a non-transitory computer-readable storage medium encoded, may cause one or more programmable processors, or other processors, to implement one or more of the techniques described herein, such as when instructions included or encoded in the non-transitory computer-readable storage medium are executed by the one or more processors. Example non-transitory computer-readable storage media may include RAM, ROM, programmable ROM (PROM), EPROM, EEPROM, flash memory, a hard disk, a compact disc ROM (CD-ROM), a floppy disk, a cassette, magnetic media, optical media, or any other computer readable storage devices or tangible computer readable media.

In some examples, a computer-readable storage medium comprises non-transitory medium. The term “non-transitory” may indicate that the storage medium is not embodied in a carrier wave or a propagated signal. In certain examples, a non-transitory storage medium may store data that can, over time, change (e.g., in RAM or cache). Elements of devices and circuitry described herein may be programmed with various forms of software. The one or more processors may be implemented at least in part as, or include, one or more executable applications, application modules, libraries, classes, methods, objects, routines, subroutines, firmware, and/or embedded code, for example.

Various examples of the disclosure have been described. Any combination of the described systems, operations, or functions is contemplated. These and other examples are within the scope of the following claims.

1. A method comprising:
receiving, by a first host device in a first network of a plurality of networks and from an intermediate client device, a request to enroll the intermediate client device into the first network;
determining, by the first host device, whether any other intermediate client device is already enrolled in the first network;
determining, by the first host device and based at least in part on the determination of whether any other intermediate client device is already enrolled in the first network, an inter-network encryption key of the first host device for encrypting communications between the plurality of networks; and
sending, by the first host device in the first network to a second host device in a second network of the plurality of networks, an encrypted message that is encrypted using the inter-network encryption key of the first host device.

2. The method of claim 1, wherein:
receiving the request to enroll the intermediate client device into the first network further includes receiving, by the first host device and from the intermediate client device, a candidate inter-network encryption key; and
determining the inter-network encryption key of the first host device further includes in response to determining that no other intermediate client device is already enrolled in the first network, setting, by the first host device, the candidate inter-network encryption key as the inter-network encryption key of the first host device for encrypting communications between the plurality of networks.

3. The method of claim 1, further comprising:
after enrolling the intermediate client device into the first network, receiving, by the first host device from a second intermediate client device, a request to enroll the second intermediate client device into the first network;
in response to receiving the request to enroll the second intermediate client device into the first network, determining, by the first host device in the first network, that the intermediate client device is already enrolled into the first network; and
in response to determining that intermediate client device is already enrolled into the first network, sending, by the first host device to the second intermediate client device, the inter-network encryption key of the first host device for encrypting communications between the plurality of networks.

4. The method of claim 3, further comprising:
in response to receiving the request to enroll the second intermediate client device into the first network, sending, by the first host device to the second intermediate client device, a security key for the host device,
wherein sending, to the second intermediate client device, the inter-network encryption key of the first host device further comprises:
encrypting, by the host device and using the security key of the host device, the inter-network encryption key to generate an encrypted inter-network encryption key of the first host device, and
sending, by the first host device to the second intermediate client device, the encrypted inter-network encryption key of the first host device.

5. The method of claim 1, wherein each of the plurality of networks is provided by a corresponding control device of a building control unit.

6. The method of claim 5, wherein:
the first host device is connected to the first network provided by a first control device of a first heating, ventilation, and air conditioning (HVAC) unit; and
the second host device is connected to the second network provided by a second control device of a second HVAC unit.

7. The method of claim 1, wherein the intermediate client device comprises one of: a temperature sensor, an outdoor sensor, a humidity sensor, an occupancy sensor, a light sensor, a current sensor, or a smoke sensor.

8. A host device comprising:
communication circuitry configured to connect to a first network of a plurality of networks;
memory,
processing circuitry operably coupled to the memory and communication circuitry and configured to:
receive, from an intermediate client device via the communication circuitry, a request to enroll the intermediate client device into the first network;
determine whether any other intermediate client device is already enrolled in the first network;
determine, based at least in part on the determination of whether any other intermediate client device is already enrolled in the first network, an inter-network encryption key of the host device for encrypting communications between the plurality of networks; and
send, to the intermediate client device via the communication circuitry, an encrypted message that is encrypted using the inter-network encryption key of the host device for forwarding to a second host device in a second network of the plurality of networks.

9. The host device of claim 8, wherein:
to receive the request to enroll the intermediate client device into the first network, the processing circuitry is further configured to receive, from the intermediate client device, a candidate inter-network encryption key; and
to determine the inter-network encryption key of the first host device, the processing circuitry is further configured to, in response to determining that no other intermediate client device is already enrolled in the first network, set the candidate inter-network encryption key as the inter-network encryption key of the first host device for encrypting communications between the plurality of networks.

10. The host device of claim 8, wherein the processing circuitry is further configured to:
after enrolling the intermediate client device into the first network, receive, from a second intermediate client device via the communication circuitry, a request to enroll the second intermediate client device into the first network;
in response to receiving the request to enroll the second intermediate client device into the first network, determine that the intermediate client device is already enrolled into the first network; and
in response to determining that intermediate client device is already enrolled into the first network, send, to the second intermediate client device via the communication circuitry, the inter-network encryption key of the host device for encrypting communications between the plurality of networks to enable the second intermediate client device.

11. The host device of claim 10, wherein:
the processing circuitry is further configured to:
in response to receiving the request to enroll the second intermediate client device into the first network, send, to the second intermediate client device, a security key for the host device,
wherein to send, to the second intermediate client device, the inter-network encryption key of the first host device, the processing circuitry is further configured to:
encrypt, using the security key of the host device, the inter-network encryption key to generate an encrypted inter-network encryption key of the first host device, and
send, to the second intermediate client device, the encrypted inter-network encryption key of the first host device.

12. The host device of claim 8, wherein each of the plurality of networks is provided by a corresponding control device of a building control unit.

13. The host device of claim 12, wherein:
the host device is connected to the first network provided by a first control device of a first heating, ventilation, and air conditioning (HVAC) unit; and
the second host device is connected to the second network provided by a second control device of a second HVAC unit.

14. The host device of claim 8, wherein the intermediate client device comprises one of: a temperature sensor, an outdoor sensor, a humidity sensor, an occupancy sensor, a light sensor, a current sensor, or a smoke sensor.

15. A method comprising:
enrolling, by an intermediate client device, in a first network of a plurality of networks;
in response to enrolling in the intermediate client device, receiving, by the intermediate client device from a first host device of the first network, a first inter-network encryption key for encrypting communications between the plurality of networks;
enrolling, by the intermediate client device, in a second network of the plurality of networks;
in response to enrolling in the second network, receiving, by the intermediate client device from a second host device of the second network, a second inter-network encryption key for encrypting communications between the plurality of networks; and
in response to determining that the first inter-network encryption key does not match the second inter-network encryption key, broadcasting, by the intermediate client device across the plurality of networks, the second inter-network encryption key for encrypting communications between the plurality of networks.

16. The method of claim 15, wherein broadcasting the second inter-network encryption key further includes:
encrypting, by the intermediate client device using the first inter-network encryption key, the second inter-network encryption key to generate an encrypted second inter-network encryption key; and
broadcasting, by the intermediate client device across the plurality of networks, the encrypted second inter-network encryption key.

17. The method of claim 15, wherein receiving the first inter-network encryption key for encrypting communications between the plurality of networks further comprises:
receiving, by the intermediate client device and from the first host device, a security key of the first network;
receiving, by the intermediate client device and from the first host device, an encrypted first inter-network encryption key; and
decrypting, by the intermediate client device and using the security key of the first network, the encrypted first inter-network encryption key to generate the first inter-network encryption key.

18. The method of claim 15, wherein the plurality of networks comprise a plurality of wireless networks.

19. The method of claim 15, wherein the intermediate client device comprises one of: a temperature sensor, an outdoor sensor, a humidity sensor, a humidity sensor, an occupancy sensor, a light sensor, a current sensor, or a smoke sensor.

20. The method of claim 15, wherein the intermediate client device comprises an internet gateway device for connecting the first network and the second network to the Internet.
